(19) United States
(12) Patent Application Publication
(10) Pub. No.: US 2010/0147154 A1
(43) Pub. Date: Jun. 17, 2010

(54) BEVERAGE PREPARATION SYSTEM, HOLDER ADN APPARATUS

(75) Inventors: Gerbrand Kristiaan De Graaff, Lisse (NL); Hendrik Cornelis Koeling, Amersfoort (NL); Ka Cheung Tsang, Amsterdam (NL); Ralf Kamerbeek, Utrecht (NL)

Correspondence Address: FOLEY & LARDNER LLP, 777 EAST WISCONSIN AVENUE, MILWAUKEE, WI, 53202-5306, US

(73) Assignee: Sara Lee/DE N.V.

(21) Appl. No.: 12/226,401

(22) PCT Filed: Apr. 19, 2007
(86) PCT No.: PCT/NL2007/050165

§ 371 Date: Aug. 11, 2009

(30) Foreign Application Priority Data
Apr. 19, 2006 (NL) 1031622
Jun. 29, 2006 (NL) 1032081

(51) Int. Cl. A47J 31/44

(52) U.S. Cl. 99/279

(57) ABSTRACT

A system for preparing a predetermined amount of beverage suitable for consumption, provided with an exchangeable holder and an apparatus provided with a fluid dispensing device which is detachably connected to the holder for supplying a first fluid under pressure to a first mixing chamber of the exchangeable holder. The exchangeable holder is provided with a storage space which is filled with a second fluid, and a fluid communication between the storage space and the first mixing chamber for dispensing the second fluid to the first mixing chamber. The holder comprises a blister pack. The fluid communication is formed by a blister chamber and is a channel having, in longitudinal direction of the channel, a first curvature in a plane parallel to a covering of the blister pack.

The invention relates to an exchangeable holder designed to be connected to an apparatus provided with a fluid dispensing device for dispensing at least a first fluid, such as a gas and/or liquid, under pressure to the exchangeable holder for preparing a beverage suitable for consumption, the exchangeable holder being provided with at least a first storage space which is filled with a second fluid such as a concentrate, the holder further being provided with at least a first mixing chamber, at least one outflow opening which is in fluid communication with the first mixing chamber for dispensing the beverage from the first mixing chamber, at least a first fluid communication between the first storage space and the first mixing chamber for dispensing the second fluid to the first mixing chamber, and at least one inlet opening which, in use, is detachably connected to an outlet opening of the fluid dispensing device, for supplying the first fluid to the first mixing chamber, wherein the first storage space forms part, at least partly, of a dosing device designed for supplying the second fluid in a dosed manner from the first storage space to the first mixing chamber, while, in use, the first fluid is also supplied under pressure to the first mixing chamber so that the second fluid and the first fluid mix together for obtaining the beverage which, then, leaves the holder via the outflow opening. The invention also relates to a system for preparing a beverage, provided with such an exchangeable holder and to an apparatus which, in use, cooperates with the holder.

Such a holder, system and apparatus are known from WO 2006/043808.

As the exchangeable holder is an exchangeable holder which, after being used once for preparing a predetermined amount of beverage suitable for consumption, such as a cup of coffee, is removed from the system by a user and ends up in the waste circuit, it is of importance that the holder can be manufactured so as to be compact and in an inexpensive manner.

It is an object of the invention to provide a solution according to which a holder for use in such a system can be manufactured, if desired, so as to be compact, and in an inexpensive manner.

According to the invention, a holder of the initially indicated type is characterized to that end in that the holder is provided with a first wall part and a second wall part extending at least substantially along a same imaginary plane, while the first wall part bounds a first part of the first mixing chamber and the second wall part bounds a first part of the first storage space, the holder further being provided with third wall part bounding a second part of the first mixing chamber and a fourth wall part bounding a second part of the first storage space, while a height of the first mixing chamber in relation to the first wall part is smaller than a height of the first storage space in relation to the second wall part.

As the height of the first mixing chamber in relation to the first wall part is smaller than a height of the first storage space in relation to the second wall part, with the first and second wall part extending at least substantially along the same imaginary plane surface, the holder can be designed to be compact.

The external volume of the holder can then, for instance, be substantially defined by the at least one first storage space. This holds in particular when the first wall part is of elongated design, while a line, perpendicular to a longitudinal direction of the first wall part, through a center of the length of the first wall part in the longitudinal direction of the first wall part, and located in the plane of the first wall part, crosses the second wall part and/or intersects the fourth wall part.

Preferably, it holds that the first mixing chamber is of elongated design. In order to compensate for the smaller greatest width of the first mixing chamber, the mixing chamber can be designed to be higher, without this leading to an essential enlargement of the holder as the height of the first mixing chamber remains smaller than the height mentioned of the first storage space.

The advantages mentioned hereinabove become even more important when the holder is further provided with a second storage space. Here, it preferably holds that the holder is further provided with a second storage space which is filled with a fourth fluid such as a concentrate, and a second fluid communication between the second storage space and the first mixing chamber for dispensing the fourth fluid to the first mixing chamber, the second storage space forming part, at least partly, of a dosing device designed for supplying the second fluid in a dosed manner from the first storage space to the first mixing chamber, while, in use, the first fluid is also supplied, under pressure, to the first mixing chamber so that, on the one side, the second fluid and/or the fourth fluid, and, on the other side, the first fluid mix together for obtaining the beverage which then leaves the holder via the outflow opening, the holder being provided with a fifth wall part extending at least substantially along the imaginary plane surface, while the fifth wall part bounds a first part of the second storage space, the holder further being provided with a sixth wall part bounding a second part of the second storage space, a height of the first mixing chamber in relation to the first wall part being smaller than a height of the second storage space in relation to the fifth wall part. The second fluid may be provided with coffee concentrate while the fourth fluid is provided with milk concentrate so that, for instance, a cappuccino can be prepared.

Here, it preferably holds that the first mixing chamber is situated between the first storage space and the second storage space. The result is that now, the external volume of the holder can be substantially defined by the volume of the first and second storage space. The first mixing chamber can lie within the external contours of the holder, which is defined by the first and second storage space.

If it is desired to provided a system for preparing a beverage utilizing holders provided with only a first storage space as well as holders provided with a first and a second storage space, the holder with the first and second storage space can be designed to be compact as indicated hereinabove, while the holder having only the first storage space can be designed as the holder with the first and second storage space while omitting the second storage space. In other words, the positioning of the first mixing chamber with respect to the first storage space with the holder having only the first storage space can be carried out in the same way as with the holder provided with the first and second storage space, while in particular with this latter holder, great advantages with respect to the compact design of the holder can be achieved when the first mixing chamber is included between the first and second storage space. The holder with only the first storage space is then compatible with the holder provided with the first and second storage space.

It preferably holds for the holder with the first and second storage space, that the first wall part is of elongated design, while a line perpendicular to a longitudinal direction of the first wall part, through a center of the length of the first wall part in the longitudinal direction of the first wall part and located in the plane of the first wall part crosses the fifth wall part and/or intersects the sixth wall part. The heights, widths and distances are external heights, widths and distances of the holder for the purpose of designing the holder compactly.

Also, according to the invention, a system according to claim 34, and an apparatus according to claim 49 and a method according to claim 53 are provided.

Specific embodiments of the invention are laid down in the dependent claims.

In the following, the invention is further elucidated with reference to the schematic Figures in the appended drawing.

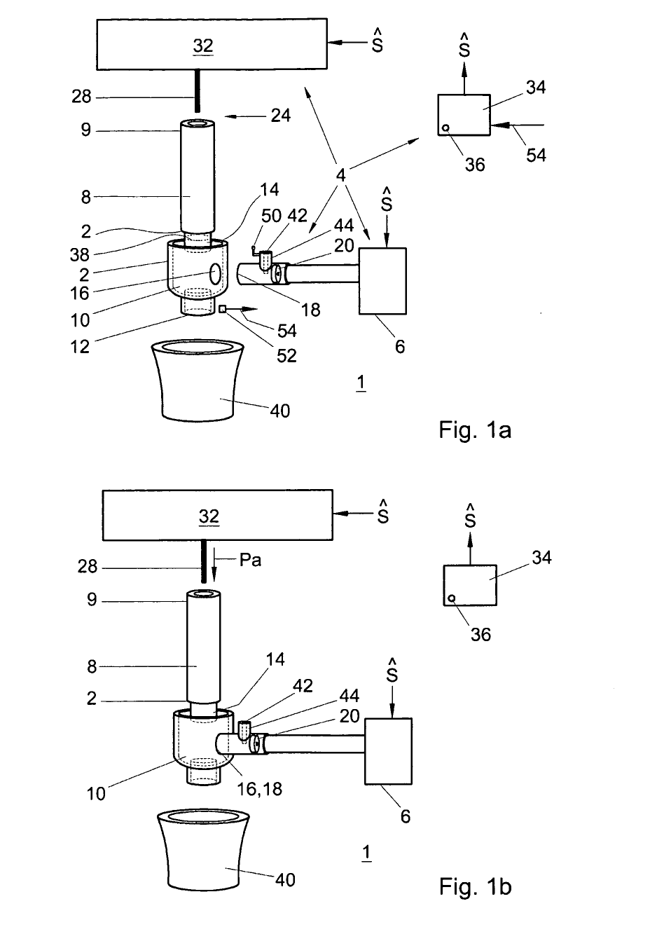

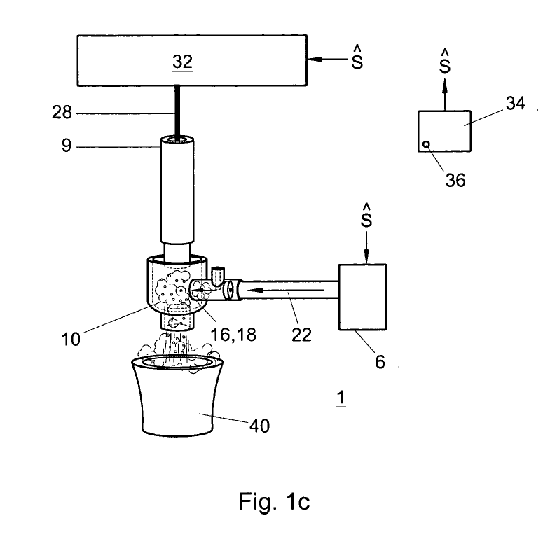

FIG. 1a shows an example of an embodiment of a known system;

FIG. 1b shows the system of FIG. 1a in an operative condition;

FIG. 1c shows the system of FIG. 1a in another operative condition;

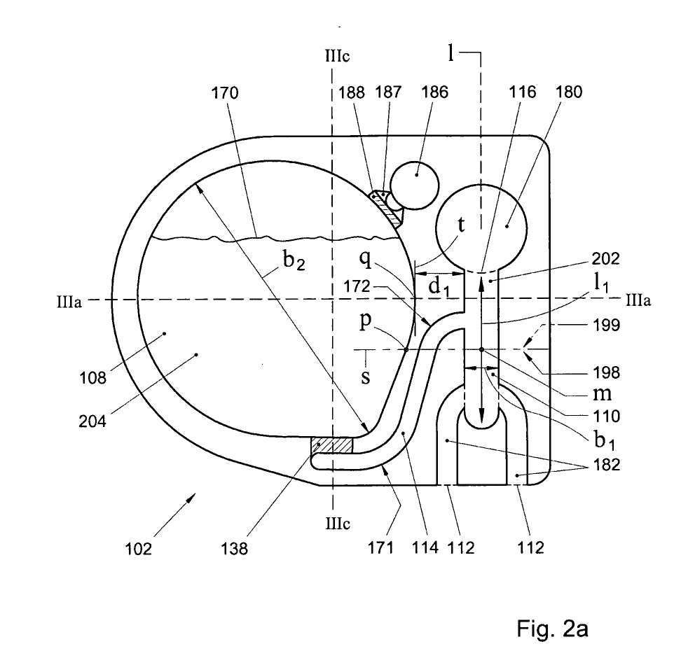

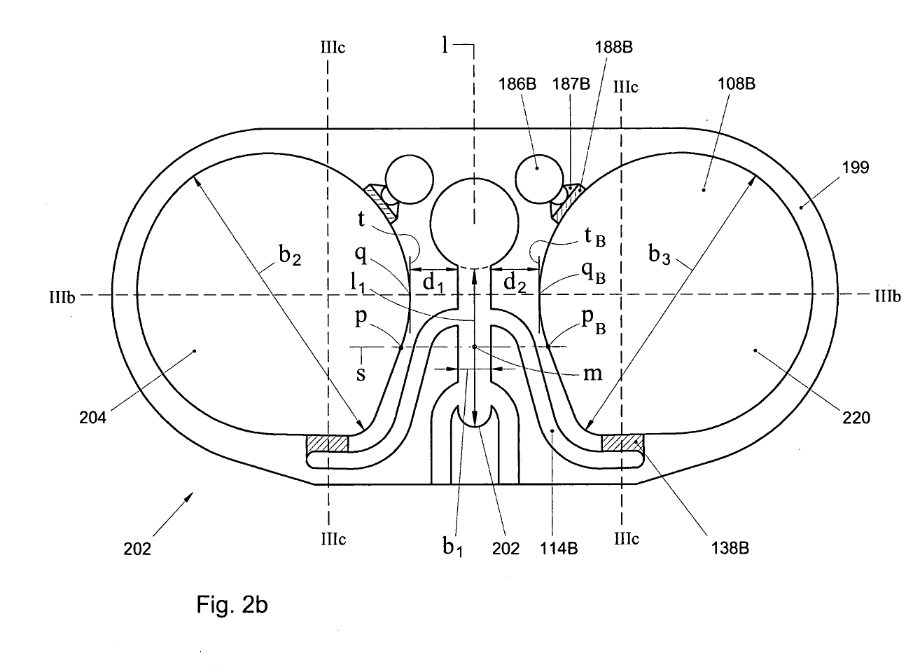

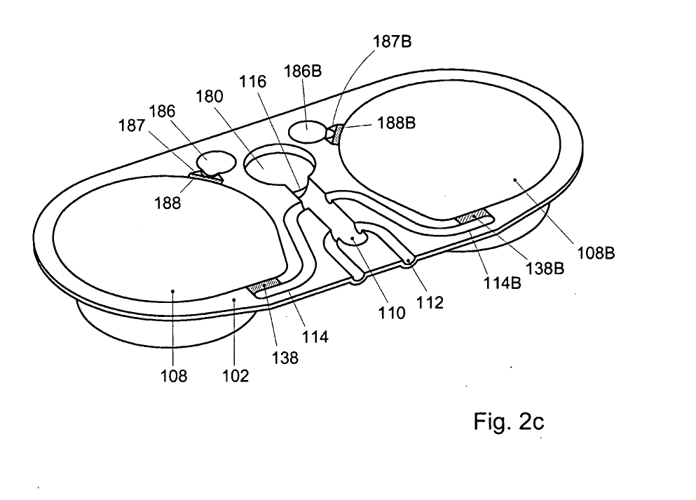

FIG. 2a shows an example of an embodiment of an exchangeable holder according to the invention;

FIG. 2b shows an example of another embodiment of an exchangeable holder according to the invention;

FIG. 2c shows, in perspective view, the holder of FIG. 2a;

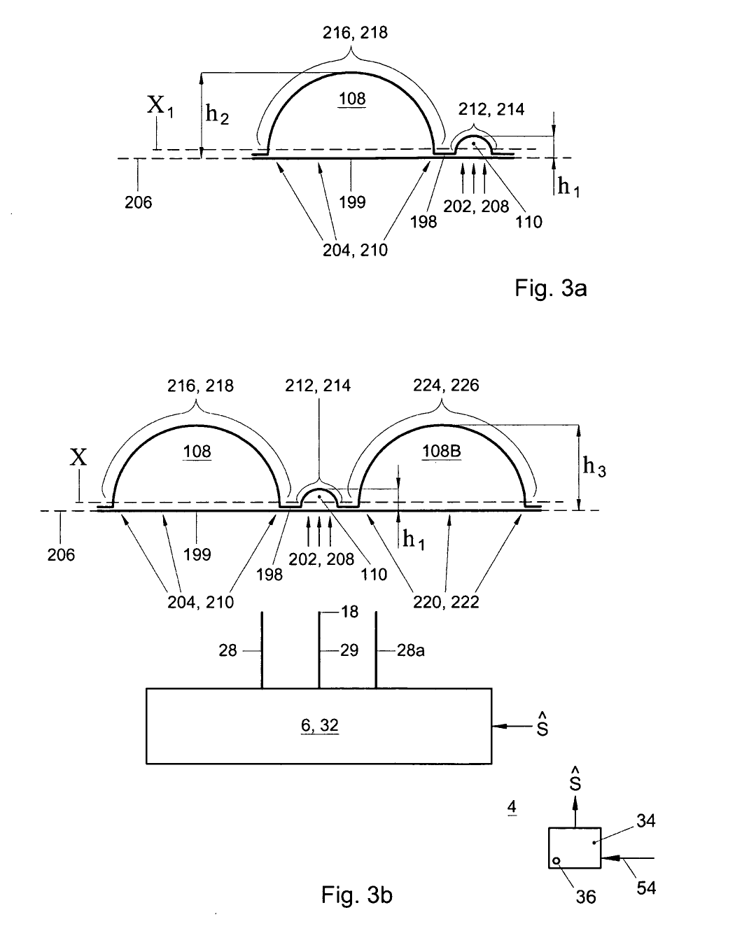

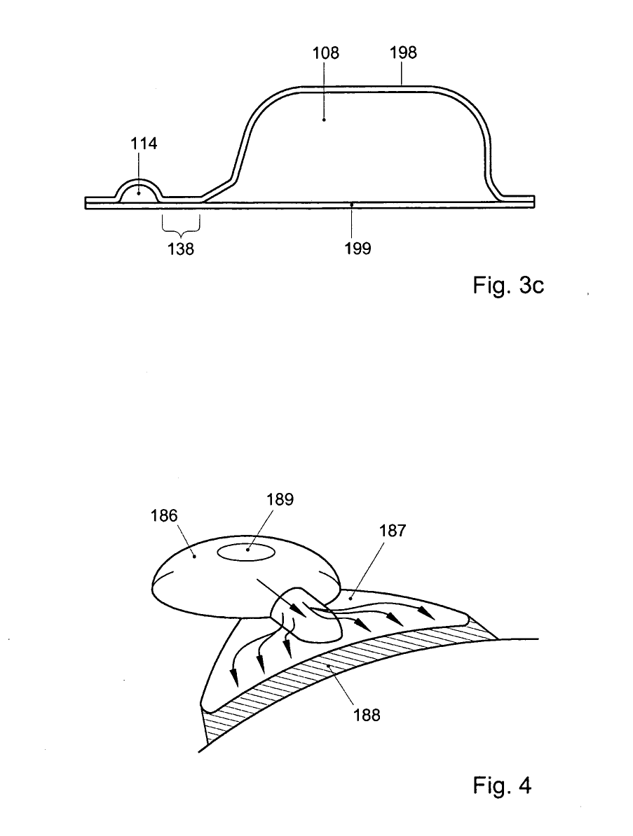

FIG. 3a shows a cross section, in a plane IIIa shown in FIG. 2a, of the holder of FIG. 2a;

FIG. 3b shows a cross section, in a plane IIIb shown in FIG. 2b, of the holder of FIG. 2b;

FIG. 3c shows a cross section, in planes IIIc shown in FIGS. 2a and 2b, of the holders of FIGS. 2a and 2b;

FIG. 4 shows a view, in perspective, of a part of the holder shown in FIG. 2a; and

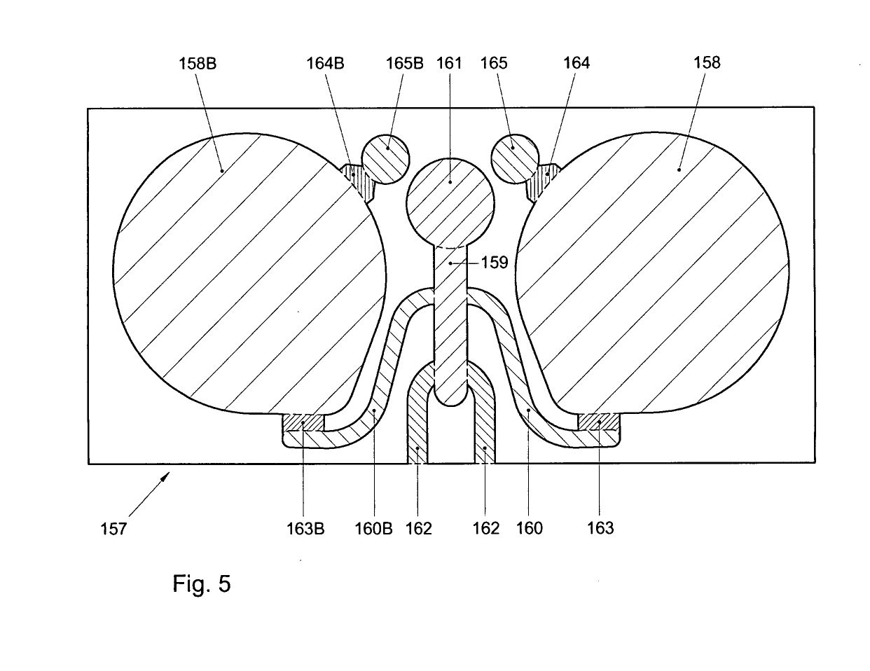

FIG. 5 shows a front view of a holder receiving portion of an apparatus of a system according to the invention.

Presently, reference is first made to FIGS. 1a-1c. In these Figures, reference 1 indicates a system for preparing a predetermined amount of beverage suitable for consumption. The system (see FIG. 1a) is provided with an exchangeable holder 2.

In FIGS. 1a-1c, for the purpose of the initial description of the system and its operation, the holder 2 is only represented in a highly schematic manner.

The system is further provided with an apparatus 4 which is provided with, inter alia, a fluid dispensing device 6 which is designed for dispensing, under pressure, at least one amount of at least a first fluid such as a liquid and/or a gas, more particularly such as water and/or steam. In this example, in use, the fluid dispensing device 6 dispenses water.

The exchangeable holder 2 is provided with at least a first storage space 8 which is filled with a second fluid such as a beverage, a concentrate or a powder. In this example, a concentrate for the preparation of coffee is involved. The holder 2 is further provided with at least a first mixing chamber 10 and at least one outflow opening 12 which is in fluid communication with the first mixing chamber 10. The holder 2 is further provided with a fluid communication 14 between the first storage space 8 and the first mixing chamber 10. The holder 2 is further provided with at least one inlet opening 16 which is detachably connected to an outlet opening 18 of the fluid dispensing device 6. In FIG. 1a, the inlet opening 16 is not yet connected to the outlet opening 18. This is, however, the case in FIG. 1b. In this example, the inlet opening 16 in FIG. 1a is still sealed off by a closure that can be removed, such as a removable seal. This also holds for the outflow opening 12. In use, both removable seals are removed, whereupon the outlet opening 18 can be connected to the inlet opening 16, as shown in FIG. 1b.

In this example, the system is further provided with a restriction 20 which is included in a fluid flow path 22 which extends, via the outlet opening 18 of the fluid dispensing device 6, the inlet opening 16 and the first mixing chamber 10, from the fluid dispensing device 6 to the outflow opening 12.

More particularly it hold in this example, that the restriction 20 is included in a fluid flow path 22 which extends, via the outlet opening 18 of the fluid dispensing device 6 and the inlet opening 16 of the exchangeable holder 2, from the fluid dispensing device 6 to the first mixing chamber 10.

The first storage space 8 forms at least a part of a dosing device 24 as will further be set forth hereinafter. In this example, this dosing device 24 is further provided with a needle 24 which, in use, is pierced through a wall of the first storage space 8 for supplying a third fluid to the second fluid in the storage space 8 for dispensing the second fluid in a dosed manner to the first mixing chamber 10. In this example, the dosing device 24 is further provided with a fluid dispensing unit 32 which is connected to the needle 28. The fluid dispensing unit 32 and the needle 28 form part of the dosing means of the apparatus 4. In this example, the fluid dispensing unit 32 is detachably connectable, at least via the needle 28, to the holder 2.

The apparatus 4 is further also provided with a control device 34 for controlling the fluid dispensing device 6 and the fluid dispensing device 32. To control the fluid dispensing device 6 and the fluid dispensing unit 32, the control device 34 generates control signals ŝ which are supplied to the fluid dispensing device 6 and the fluid dispensing unit 32. In this example, the control device 34 is designed for controlling the fluid dispensing device 6 and the fluid dispensing unit 32 independently of each other.

The system 1 described heretofore works as follows. For the purpose of preparing a predetermined amount of beverage suitable for consumption, the exchangeable holder 2 is placed in the apparatus 4. Here, the first storage space 8 of the exchangeable holder 2 is placed under the needle 28. Also, as shown in FIG. 1b, the outlet opening 18 is connected to the inlet opening 16. The apparatus is now ready for use. By pushing, for instance, a button 36 of the control device 34, the control device provides for the fluid dispensing unit 32 to move the needle 28 in the direction of the arrow Pa. The result thereof is that the needle 28 is pierced through a wall of the first storage space 8 and the third fluid is supplied under pressure to the second fluid in the storage space. Consequently, the third fluid will apply a pressure and/or force to the second fluid. Hence, in this example, the pressure in the first storage space 8 will increase. Here, the fluid communication 14 can for instance further be provided with a seal 38, in the form of, for instance, a breakable skin 38, which tears open due to the increase of the pressure in the first storage space 8 resulting from the supply of the third fluid. As a result, in this example, the coffee concentrate will flow in a dosed manner from the storage space 8 via the fluid communication 14 to the first mixing chamber 10. Simultaneously, or soon after, the control device 34 ensures that the fluid dispensing device 6 is activated. This results in that the fluid dispensing device 6 starts dispensing the first fluid under pressure, in this example water (FIG. 1c). In this example, this water is hot water with a temperature of, for instance, 80-98° C. This hot water flows via the fluid flow path 22 to the restriction 20. Having arrived at the restriction 20, a jet of the hot water is generated by means of the restriction 20. This jet spouts via the outlet opening 18 and the inlet opening 16 into the first mixing chamber 10. In the first mixing chamber 10, the hot water will start mixing well with the concentrate. Here, the flow rate at which the concentrate is supplied to the mixing chamber 10 is regulated by the control device 34, through control of the fluid dispensing unit 32. Further, the flow rate at which the hot water is supplied to the first mixing chamber 10 is also regulated by the control device 34 through control of the fluid dispensing device 6. In the first mixing chamber, as a result of the jet, the concentrate will mix well with the hot water, so that the beverage is formed. This beverage can then leave the outflow opening 12 and be captured in, for instance, a mug 40.

As, with the system 1, both the dosing of the concentrate over time and the dosing of the hot water over time can be regulated well, it can be ensured that the concentration of the amount of concentrate in the beverage can be accurately determined. Furthermore, it can be ensured that the beverage which, during its preparation, leaves the outflow opening 12, is of constant quality, i.e., the concentration of the concentrate in the beverage that is dispensed can be kept constant during dispensing, if desired. The fact is that in this example, the flow rate of the water and the flow rate of the concentrate supplied to the first mixing chamber 10 can each, if desired, be controlled independently of each other. Therefore, it holds in this example, that the system 1 is designed such that the fluid dispensing device 6 and the dosing device 24 can supply, independently of each other, the first fluid and the second fluid, respectively, to the first mixing chamber 10. This entails that the size of the flow rate of the first fluid and the period during which the first fluid is dispensed are independent (in this example through control of the control device) of the size of the flow rate of the second fluid and the period during which the second flow rate is dispensed.

It further holds in this example, that the dosing device 24 is a controllable and active dosing device for supplying the second fluid to the first mixing chamber by applying an increased pressure or force to the second fluid. Herein, an active dosing device is understood to mean that the second fluid flows through the fluid communication from the storage space to the first mixing chamber as a result of an excess pressure or force applied on the side of the storage space.

In the example, the system 1 is further provided with an air inlet opening 42. The air inlet opening 42 ensures that air is supplied to the first mixing chamber 10 so that, in use, air is whipped into the beverage for obtaining a beverage with a fine-bubble froth layer. Thus, for instance, a café crème can be obtained. In this example, the air inlet opening 42 is in fluid communication with the first mixing chamber 10 downstream of the restriction 20. In this example, the air inlet opening 42 terminates, via a fluid communication 44, into the fluid flow path 22. In this example it therefore holds, that the air inlet opening 42 and the restriction 20 each form part of the apparatus 4. However, this is not required. It will be clear that the air inlet opening 42 and/or the restriction 20 can form part of the exchangeable holder 2.

After the beverage, in this example coffee with a fine-bubble froth layer, has been prepared, the control device 34 stops the fluid dispensing device 6. The control device 34 also ensures that the third fluid is no longer supplied to the second fluid in the storage space, and that the needle 28 is retracted from the respective wall of the first storage space 8, i.e., in a direction opposite that of the arrow Pa. Here, it may be such that the control device 34 first provides that the dispensing of the second fluid to the first mixing chamber is stopped and that after that, the supply of the first fluid (in this example, water) is stopped. Thus, the risk of the second fluid contaminating, for instance, the restriction 20 is reduced.

FIG. 1c shows a situation where the needle 28 is pierced through a wall of the first storage space 8 and the third fluid is supplied under pressure to the second fluid in the storage space 8. The situation shown occurs at the moment when the control device 34 will stop the supply of hot water to the mixing chamber 10, will no longer effect the supply of the third fluid to the second fluid in the storage space 8, and will effect the retraction of the needle 28 from the respective wall of the storage space 8 so that, thereupon, the holder 2 can be taken from the apparatus 4 again.

After this, a user can remove the exchangeable holder 2 and, if a new amount of beverage is to be prepared, place a new exchangeable holder in the apparatus 4. The new exchangeable holder can be provided with an entirely different type of second fluid such as, for instance, a milk concentrate. When, with the aid of the new exchangeable holder, milk is prepared in a manner comparable to that as described for the preparation of coffee based on coffee concentrate, in the prepared milk, no trace will be found of the previously prepared type of beverage. The fact is that the first mixing chamber 10 forms part of the exchangeable holder and when a new exchangeable holder is placed in the apparatus 4, also, an entirely new and, hence, clean first mixing chamber is placed in the holder. Therefore, contamination cannot be involved.

In the example of FIGS. 1a-1c, the dosing device 24 is designed for supplying the third fluid under pressure to the second fluid in the storage space 8 for dispensing the second fluid in a dosed manner to the first mixing chamber 10. It will be clear that in addition or as an alternative, the dosing device 24 can be provided with a compressing unit for compressing the storage space 8 for dispensing the second fluid to the first mixing chamber in a dosed manner, as described in, for instance, WO 2006/04380.

In the example of FIGS. 1a-1c, the jet of the first fluid spouts into the first mixing chamber 10. It is possible that here, the jet impacts on an inside wall of the first mixing chamber 10, while swirls are formed in the first mixing chamber 10, resulting in that the second fluid, the first fluid and, optionally, air are mixed together. It is also possible that the jet impacts on a jet impact element in the first mixing chamber 10. Upon impact of the jet on the jet impact element, the liquid is atomized, so that air can be whipped in well.

As indicated above, for the purpose of the initial description of the system and its operation, the holder 2 is only represented in the FIGS. 1a-1c in a highly schematic manner. For the further description of the holder 2, presently, reference is first made to FIGS. 2a, 3a and 3c in which this holder for use in the system shown in FIGS. 1a-1c is shown in an embodiment according to the invention.

The holder 2 shown in FIGS. 1a-1c, storage space 8, first mixing chamber 10, outflow opening 12, fluid communication 14, inlet opening 16 and fluid communication seal 38 are indicated in FIGS. 2a and 3 as the holder 102, the first storage space 108, the first mixing chamber 110, the outflow opening 112, the fluid communication 114, the inlet opening 116 and the fluid communication seal 138, respectively. It is noted that in the example shown, the holder 102 has two of such outflow openings 112. In this example, the holder 102 is designed as a blister pack 102. This is, however, not required.

The blister pack 102 is provided with blister chambers and a covering 199 of the blister chambers. FIG. 2a is a top plan view to the side of the blister pack where the material 198 is located of which the blister chambers have been deep-drawn. On the opposite side is situated the covering 199 of the blister chambers (FIG. 3c). The storage space 108, the first mixing chamber 110 and the fluid communication 114 between the storage space 108 and the first mixing chamber 110 are each formed by one of the blister chambers. In this example, the first mixing chamber 110 is connected to the two outflow openings 112 via two outflow channels 182 formed by further blister chambers of the blister pack.

The blister pack 102 is further provided with the fluid communication seal 138 for bringing the fluid communication 114 into operation through removal of the sealing action of the fluid communication seal 138. In the example shown, the fluid communication seal 138 is a peel seal 138.

The fluid communication 114 is a channel which is not straight in longitudinal direction of the channel. It is for instance shown in FIG. 2a that the fluid communication 114 has, in longitudinal direction of the channel, a first curvature 171 in a plane parallel to the covering 199.

The blister pack 102 is further provided with a chamber 180 which communicates, via the inlet opening 116 with the first mixing chamber 110. Via this chamber 180, the outlet opening 18 of the fluid dispensing device 6 can be connected to the inlet opening 116 with the aid of, for instance, a needle with the outlet opening 18 which pierces through the covering 199 into the chamber 180.

The blister pack 102 is further provided with a blister chamber 186, which is also shown in FIG. 4. This blister chamber 186 communicates, via a zone 187 in which the material 198 of which the blister chambers have been deep-drawn is not attached to the covering 199, with a peel seal 188 which is similar to the above-mentioned peel seal 138. The peal seal 188 adjoins the storage space 108. The needle 28 (see FIG. 1) of the dosing device 24 can be pierced through a wall portion 189 (see FIG. 4) of the chamber 186. In this manner, the third fluid can be supplied to the chamber 186, whereupon the third fluid can be supplied under pressure via the zone 187 and the peel seal 188 to the storage space 108. With the aid of arrows, in FIG. 4, the flow direction of the third fluid is indicated. In this example, with the aid of the zone 187, a relatively great effective surface of the peel seal 188 is obtained, upon which surface the pressure of the third fluid can act for opening the peel seal 188.

Reference is now made to FIG. 5. In FIG. 5 is shown a holder receiving portion 157 of the apparatus 4. The holder receiving portion 157 is designed for detachably receiving the holder 102 for preparing a beverage suitable for consumption. The holder receiving portion 157 is provided with blister chamber receiving recesses for receiving blister chambers of the holder 102. For instance, a first blister chamber receiving recess 158 is designed for receiving the blister chamber of the first storage space 108, a second blister chamber receiving recess 159 for receiving the blister chamber of the first mixing chamber 110, and a third blister chamber receiving recess 160 for receiving the blister chamber of the fluid communication 114. Viewed in cross sections through a plane parallel to the covering 199 of the holder 102 received in the holder receiving portion 157, these blister chamber receiving recesses 158, 159, 160 have contours that correspond, at least partly, to contours of the blister chambers of the storage space 108, the first mixing chamber 110 and the fluid communication 114.

The holder receiving portion 157 is further provided with further recesses, i.e. a recess 161 for receiving the chamber 180, two recesses 162 for receiving the outflow channels 182, a recess 163 for receiving the peel seal 138 and having it detach under pressure, a recess 164 for receiving the zone 187 and the peel seal 188 and having them detach under pressure, and a recess 165 for receiving the blister chamber 186.

It is noted that in FIG. 5, a recess is less deep according as hatching lines indicated in this recess lie closer together. For instance, in the example of FIG. 5, the first blister chamber receiving recess 158 (intended for the first storage space 108) is deeper than the second blister chamber receiving recess 159 (intended for the first mixing chamber 110), which, in turn, is deeper than the third blister chamber receiving recess 160 (intended for the fluid communication 114). However, other mutual depth proportions for the different recesses are also possible within the framework of the invention. It is further noted that the view shown in FIG. 5 is a view in the direction of increasing depth of the recesses.

For preparing a beverage suitable for consumption, the holder 102 shown in FIG. 2a can be placed by a user in the holder receiving portion 157 of the apparatus 4 shown in FIG. 5. In placed condition, the holder 102 is situated substantially at the center part and right hand part of the holder receiving portion 157 shown in FIG. 5. Thus, the preparation of the beverage can take place as described hereinabove with reference to FIGS. 1a-1c.

In placed condition, the holder 102 is, in operation, preferably in a position such that the outflow opening(s) 112 are situated on a side facing downward of the first mixing chamber 110. Here, the holder 102 can, for instance, be placed such that the covering 199 of the blister pack 102 is placed vertically. When placing in the holder receiving portion 157, the blister pack 102 may still be placed with the cover 199 of the blister pack 102 horizontally, and then, for bringing the system in the operative condition, the holder receiving portion 157 can be turned such that the blister pack 102 is placed vertically.

In FIG. 2a, reference numeral 170 indicates the level of the second fluid in the storage space 108 when the holder 102 is placed and is in operative condition. According as, in operation, more and more of the second fluid is supplied to the first mixing chamber, the level 170 drops more and more. In order to optimally empty the storage space 108, it is advantageous when, in operation, the location where the second fluid flows from the storage space 108, is situated as far downwards as possible. In the example shown, the peel seal 138 is therefore situated at such a position as far downwards as possible relative to the storage space 108.

The above-mentioned correspondence of the contours of the blister chamber receiving recesses with the contours of the blister chambers offers the advantage that in operation, the holder receiving portion 157 contributes to the walls of the blister chambers being held in place when pressure is applied to these walls. This being the case, it is advantageous when parts of the contours of the blister chamber receiving recess 160 of the holder receiving portion 157 correspond at least partly to parts of the contours of the first curvature 171 of the fluid communication 114. It is further advantageous in this respect, when parts of the contours of the blister chamber receiving recess 160 of the holder receiving portion 157 correspond at least partly to parts of the contours of the second curvature 172 of the fluid communication 114 so that the blister chamber recess 160 proceeds at least partly in an S-shape.

Presently, reference is made to FIG. 2b, in which a holder 202 is shown. The difference between the holders 102 and 202 is that the holder 202 comprises a second storage space 108B, similar to the storage space 108, and a second fluid communication 114B, similar to the fluid communication 114. In the two storage spaces 108 and 108B, mutually different second fluids may be stored, for instance in one storage space a second fluid in the form of a coffee concentrate and, in the other storage space, a fourth fluid in the form of a milk concentrate. The holder 202 also comprises a second chamber 186B, a second zone 187B, a second peel seal 188B, and a second peel seal 138B, each similar to the chamber 186, the zone 187, the peel seal 188 and the peel seal 138, respectively. It is noted that in FIG. 2b, for the sake of clarity, the reference numerals indicated in FIG. 2a are not included again.

The holder 202 having the two storage spaces 108 and 108B can be used in a system which is provided with a dosing device which is designed for dispensing the second and fourth fluids in a dosed manner to the first mixing chamber from the two different storage spaces. With respect to the example shown in FIG. 1, the dosing device can comprise, to that end, in addition to the needle 28, for instance a second needle, while the second needle can then be introduced into the second chamber 186B. Here, with the aid of the second needle, the apparatus 4 can supply a fifth fluid, such as a gas and/or a liquid, to the fourth fluid in the second storage space for the dosed supply of the fourth fluid from the second storage space to the first mixing chamber. Here, the fifth fluid can be of the same type as the third fluid which is supplied to the first storage space 108 by means of the needle 28. The apparatus can therefore be provided with a fluid dispensing device 32 provided with a first needle 28 and a second needle 28a via which, independently of each other, the third fluid and the fifth fluid can be supplied to the second fluid in the first storage space 108 and to the fourth fluid in the second storage space 108a, respectively. This part of the apparatus, and the fluid dispensing device 6 are schematically shown in FIG. 3b.

For preparing a beverage suitable for consumption, also, the holder 202 can be placed on the holder receiving portion 157 of the apparatus 4 shown in FIG. 5. The holder receiving portion 157 shown in FIG. 5 is therefore suitable for the holder 102 shown in FIG. 2a, as well as for the holder 202 shown in FIG. 2b.

Preferably, the two storage spaces 108 and 108B are situated on opposite sides of the first mixing chamber 110 and, also, the two fluid communications 114 and 114B are situated on opposite sides of the first mixing chamber 110, as is the case in the example shown in FIG. 2b. In this manner, the compactness of the holder 202 is realized, while then, the associated holder 102 having only one storage space 108 but still fitting in the same holder receiving portion 157, is also compact.

More particularly, the following can be noted here. The holder according to FIGS. 2a, 3a is provided with a first wall part 202 and a second wall part 204 which extend, at least substantially, along the same imaginary plane surface 206. Here, the first wall part bounds a first part 208 of the first mixing chamber 110. The second wall part 204 bounds a first part 210 of the first storage space 108. It further appears from FIG. 3a that the holder is further provided with a third wall part 212 which bounds a second part 24 of the first mixing chamber 110, and a fourth wall part 216 which bounds a second part 218 of the first storage space 108. It holds here that the height h1 of the first mixing chamber 110 in relation to the first wall part 202 is smaller than a height h2 of the first storage space 108 in relation to the second wall part 204. As a result, the holder according to FIG. 3a can be of compact design. Here, the external height h1 of the first mixing chamber and the external height h2 of the first storage space are involved. In fact, these external heights are equal to internal heights as here, a thin-walled blister pack is involved.

In particular it holds here that the first wall part 202 is of elongated design while a greatest width b1 of the first wall part, perpendicular to a longitudinal direction 1 of the first wall part (see FIG. 2a) is smaller than a greatest width b2 of the second wall part. It further holds that the first wall part 202 is of elongated design, while a greatest length l1 of the first wall part 202 in the longitudinal direction l of the first wall part 202 is smaller than a greatest width b2 of the second wall part 204. For b1, b2, b3, d1 and 2d it also applies that they relate to external dimensions of the holder. For l₁ it applies that it is defined, on the one side, relative to an outside of the holder and, on the other side, relative to the dotted line shown of FIGS. 2a and 2b.

In this example, it further holds that the first mixing chamber is of elongated design. As already stated, it further holds that the first wall part 202 is of elongated design, while a line S, perpendicular to a longitudinal direction l of the first mixing chamber 110, which line S further runs through a center m of the length of the first wall part 202 in the longitudinal direction l of the first wall part, and is further located in the plane of the first wall part (in this example the plane 206) crosses the second wall part 204 (see FIG. 2a). It can also be stated that the line S intersects the fourth wall part 216. The point of intersection P is also indicated in FIG. 2a. By thus positioning the first mixing chamber relative to the first storage space, the holder can be designed to be particularly compact.

It further holds that a longitudinal direction of the first mixing chamber (here also indicated with the line l in FIG. 2a) is parallel to the first wall part 202 and is directed at least virtually parallel to a line t located in the plane of the first wall part 202 and which is a tangent line on the fourth wall part 216 at a point q of the fourth wall part where the distance, d1 between the third wall part 212 and the fourth wall part 216 in the plane of the first wall part 202 is minimal. It preferably holds that this distance d1 is at least virtually equal to the width b1 mentioned. Thus, a holder can be designed very compactly.

As stated, it holds in FIG. 2b that the first mixing chamber 110 is located between the first storage space 108 and the second storage space 108b. The properties described hereinabove with regard to the first storage space relative to the first mixing chamber also hold, mutatis mutandis, for the second storage space 108b relative to the first mixing chamber 110. It therefore holds that the holder is further provided with a second storage space 108b filled with a fourth fluid such as a concentrate. Further, there is a second fluid communication between the second storage space and the first mixing chamber for dispensing the fourth fluid to the first mixing chamber 110, with the second storage space 108b forming part, at least partly, of a dosing device designed for the dosed supply of the fourth fluid from the second storage space to the first mixing chamber 110. The holder of FIG. 3b is provided with a fifth wall part 220 which extends, at least substantially, along the imaginary plane 206, while the fifth wall part 220 bounds a first part 202 of the second storage space 108b, and wherein the holder is further provided with a sixth wall part 224 bounding a second part 226 of the second storage space 108b. It further holds that the height h1 of the first mixing chamber in relation to the first wall part 202 is smaller than a height h3 of the second storage space 108b in relation to the fifth wall part 220 (see FIG. 3b). Here, too, the external height h3 of the second storage space 108b is involved which, in this example, is in fact equal to the internal height of the second storage space as, here, a thin-walled blister pack is involved. It also holds, as shown in FIG. 2b, that the first wall part is of elongated design while a greatest width b1 of the first wall part, perpendicular to a longitudinal direction l of the first wall part is smaller than a greatest width b3 of the fifth wall part 220. It further holds that a greatest length l1 of the first wall part in a longitudinal direction l of the first wall part is smaller than a greatest width b3 of the fifth wall part 220.

It further holds that a line S, perpendicular to a longitudinal direction l of the first wall part, which line also runs through a center m of the length l1 of the first wall part in the longitudinal direction l of the first wall part, and which line is located in the plane of the first wall part 202, crosses the fifth wall part 220. It also holds that this line intersects the sixth wall part 224. The point of intersection is indicated with PB in FIG. 2b.

It further holds that in FIG. 2b, a longitudinal direction of the first mixing chamber is parallel to the first wall part and is directed, at least virtually, parallel to a line tB situated in the plane of the first wall part 202 and which is a tangent line on the sixth wall part 224 at a point qB of the sixth wall part where the distance d2 between the sixth wall part and the third wall parts 212 is minimal. It further holds in particular that the distance d2 is approximately equal to the width b1 mentioned. Thus, a particularly compact holder is obtained, as shown in FIG. 2b.

For the example in FIGS. 2 and 3, it holds that the first wall part and the second wall part are manufactured in one piece. Here, the one piece involves the covering 199. This covering can be manufactured from, for instance, a flexible foil. It also holds for the holder according to FIGS. 2 and 3 that the third wall part and the fourth wall part are manufactured in one piece. It further holds that, combined, the first wall part 202 and the third wall part 212 form the first mixing chamber. It further holds that, combined, the second wall part 204 and the fourth wall part 216 form the first storage space. In this example, with the embodiment according to FIG. 3 it holds that the first wall part 202, the second wall part 204 and the fifth wall part 220 are manufactured in one piece. Here, too, this one piece is the covering 199. It further holds here that the third wall part 212, the fourth wall part 216 and the sixth wall part 224 are manufactured in one piece. It further holds, in FIG. 3 that, combined, the fifth wall part and the sixth wall part form the second storage space 108b.

It further holds both for the holder according to FIG. 2 and for the holder according to FIG. 3 that the first wall part, the second wall part, the third wall part and the fourth wall part each form part of an outside wall of the holder. It further holds for the embodiment according to FIG. 3, that the first wall part, the second wall part, the third wall part, the fourth wall part, the fifth wall part and the sixth wall part each form part of an outside wall of the holder. With the embodiment according to FIG. 2, it further holds that the first wall part and the second wall part are manufactured from a foil and that the third wall part and the fourth wall part are manufactured from a material that is more rigid than the foil. It further holds with the embodiment according to FIG. 3, that the first wall part, the second wall part and the fifth wall part are manufactured from a foil (covering 199) and that the third wall part, the fourth wall part and the sixth wall part are manufactured from a material that is more rigid than the foil. For b1, b2, b3, d1 and d2 it also applies that they relate to external dimensions of the holder. For l₁ it applies that it is defined, on the one side, relative to an outside of the holder and, on the other side, relative to the dotted line shown of FIGS. 2a and 2b.

It further holds for the embodiment according to FIGS. 2 and 3, that the holder is designed in a manner such that in use, a third fluid can be supplied in a controlled manner, under pressure, by the apparatus, to the second fluid in the first storage space for dispensing the second fluid in a dosed manner from the storage space to the first mixing chamber. Owing to the pressure of the third fluid in the first storage space, the second fluid is dispensed from the first storage space to the first mixing chamber. Therefore, the third fluid applies a pressure and/or force to the first fluid. It is, however, also conceivable that it holds that the fourth wall part is manufactured of a flexible or deformable material, so that the storage space can be squeezed together for the dosed supply of the second fluid from the first storage space to the first mixing chamber. In that case, the holder will, generally, not be included in a holder receiving portion as shown in FIG. 5, but be squeezed empty with the aid of an apparatus as described in, for instance, WO 2006/043808.

It further holds for the apparatus according to FIG. 3, that the holder is designed in a manner such that, in use, the apparatus can supply, in a controllable manner, under pressure, a fifth fluid to the fourth fluid in the second storage space for dispensing the fourth fluid in a dosed manner from the second storage space to the first mixing chamber. Owing to the pressure of the fifth fluid, the fourth fluid is dispensed from the second storage space to the first mixing chamber. Here, the fluid applies a pressure and/or force to the second fluid. However, it is also conceivable that for the embodiment according to FIG. 3 it holds that the sixth wall part is manufactured from a flexible or deformable material, so that the second storage space can be squeezed together for the dosed supply of the fourth fluid from the second storage space to the first mixing chamber. Here, rather, squeezing the second storage space 108b of an apparatus of a type as described in WO 2006/043808 will be applied too.

In FIG. 3b, for the sake of completeness, it is further indicated that, in addition to the fluid dispensing unit 32, the apparatus also comprises the fluid dispensing device 6 provided with an outlet opening 18 which is also formed by the extremity of a needle 29. This needle 29 can be pierced through a wall (formed by, for instance, covering 299) of the chamber 180, so that the outlet opening 18 of the apparatus 4 is detachably connected via the chamber 180 to the inlet opening 116 of the holder. Here, this holds for both variants according to FIGS. 2a and 2b, while, when the holder according to FIG. 2a is used with the apparatus as schematically shown in FIG. 3b, it holds for the apparatus according to FIG. 3b that the needle 28a is not used. If, by contrast, the holder according to FIG. 2 is used with the apparatus according to FIG. 3b, then, each of the needles 28, 28a, 29 are used. It should be noted here that then, the apparatus 4 as shown in FIG. 3b is further provided with the holder receiving portion of the apparatus as shown in FIG. 5. The holder shown in FIG. 3b is therefore located between the holder receiving portion of the apparatus as shown in FIG. 5 and the fluid dispensing device 6 and the fluid dispensing unit 32 with the needles 28, 28a and 29 as shown in FIG. 3b.

As stated, the fluid communication 114 is a channel which, in longitudinal direction of the channel, has a first curvature 171 in a plane parallel to the covering 199. It is further advantageous when the channel has a second curvature in said longitudinal direction in this plane, indicated with reference numeral 172 in FIG. 2a, which second curvature is the opposite of the first curvature so that the channel has an S-shaped portion. The second curvature 172 contributes to a further extent to the earlier stated effects that are also achieved with the first curvature 171, i.e., contributing to an increased flow resistance of the channel. In addition, with the aid of the second curvature 172, the fluid communication 114 can be designed such that a favourable inflow of the second fluid in the first mixing chamber 110 can be realized. Thus, it can for instance be ensured, with the aid of the second curvature 172, that the fluid communication 114 links up at a more or less locally right angle to the first mixing chamber 110, so that the second fluid, upon entering the first mixing chamber 110, on the one side, does not tend too much towards the direction of the inlet opening 116, and, on the other side, does not tend too much towards the outflow openings 112.

In order to avoid that the second fluid does not obtain sufficient opportunity to mix with the first fluid in the first mixing chamber 110, it is advantageous that the location where the fluid communication 114 links up with the first mixing chamber is not too close to the location where the outflow channels 182 link up with the first mixing chamber 110. When the first mixing chamber 110 is provided with an air inlet opening for supplying air to the first mixing chamber, so that, in use, air is whipped into the beverage for obtaining a beverage with a fine-bubbled froth layer, it is advantageous that the location where the fluid communication 114 links up with the first mixing chamber is not too close to the air inlet opening, as otherwise, a favourable supply of air can be disturbed. Through the use of the first curvature 171 and the second curvature 172, for these and other reasons, desired connections of the fluid communication 114 to the first mixing chamber 110 can be realized.

It is advantageous when the cross section of a fluid communication is not too large and the length of a fluid communication is not too small. It is preferred that the maximum cross section of a fluid communication varies from, for instance, 1 to 3 mm, more particularly from 1.5 to 2.5 mm. Preferably, the length of a fluid communication varies from, for instance, 2 to 5 cm, more particularly from 3 to 4 cm. Such cross sections, that are not too large and lengths that are not too short of a fluid communication, prevent the storage space from emptying undesirably rapidly when the second fluid is, for instance, a low viscous product. What can be achieved with such cross-sections that are not too great and lengths that are not too short of a fluid communication is, that a fluid communication of a particular size is suitable for use in different holders containing different sorts of second fluids. Here, for such a fluid communication of a specific size, a matching holder receiving recess 160 of the holder receiving portion 157 can be used, so that the holder receiving recess 160 is also suitable for different holders with different sorts of second fluids.

The invention is not limited in any manner to the embodiments outlined hereinabove. For instance, the holder can further be provided between the first mixing chamber 110 and the outflow opening 112 with a second mixing chamber 111. Here, there is a fluid communication between the first mixing chamber and the second mixing chamber, and the two outflow openings are in fluid communication with the second mixing chamber. The concept of the second mixing chamber is described in WO 2006/043808. The second and/or fourth fluids are, for instance, mixable and/or soluble in the first fluid. In the example, the storage spaces mentioned were filled with coffee concentrate and/or milk concentrate. Other fluids, based or not based on concentrate, are also conceivable, for instance, a squash or powder for preparing a lemonade can be considered. The apparatus can further also be provided with additional storage spaces which are filled with, for instance, additives such as, for instance, soluble powders or concentrates. These powders too may be supplied to the first mixing chamber by, for instance, forcing out through a third fluid and/or fifth fluid, or by emptying the respective storage space through squeezing. Here, for instance, flavour enhancers, sugars, cocoa and the like can be involved. Also, milk powder and/or milk creamer can be considered. Generally, it holds that, apart from a liquid such as a concentrate, the second fluid and/or fourth fluid can also be a powder and the like, soluble in the first fluid or mixable with the first fluid, for instance soluble in a liquid such as water. A second and/or fourth fluid in the storage space can also comprise both a concentrate and a powder, in mixed form or not in mixed form. An exchangeable holder can also, instead of one or two storage spaces for the second and fourth fluids, respectively, have more than two storage spaces for fluids. Consequently, the holder can comprise, instead of one or two fluid communications, also more than two fluid communications.

Such variants are each understood to fall within the framework of the invention. The temperature of the first fluid can vary. The first fluid can for instance also consist of water at room temperature, or cold water. The temperature of the first fluid which is supplied to the holder for preparing a beverage can also vary over time.

The volume of a storage space can for instance vary from 5 to 150 ml, more particularly from 6 to 50 ml. A passage opening of the restriction can for instance vary from 0.4 to 1.5 mm, more particularly from 0.6 to 1.3 mm, still more particularly from 0.7 to 0.9 mm. The pressure at which, in use, the liquid dispensing device dispenses the first fluid can vary from 0.6 to 12 bars, more particularly from 0.7 to 2 bars and preferably from 0.9 to 1.5 bars. The period during which the first fluid is supplied to the first mixing chamber for preparing the beverage can vary from 2 to 90 seconds, more particularly from 10 to 50 seconds. The size of the air inlet opening, when this is fully opened, can vary from, for instance, 0.005 to 0.5 mm². In this example, the holder according to FIGS. 2 and 3 is designed as a blister pack. This is, however, not required. The holder can also be composed of more parts. In FIG. 2b, for instance, an interrupted line x indicates where different plastic parts are sealed together. Hence, this package is built up from four parts (three above the interrupted line and one below the interrupted line). Completely analogously, the holder according to FIG. 3a can be built up from two parts above the interrupted line and one part below the interrupted line. Such variations also belong to the invention.

1. An exchangeable holder designed to be connected to an apparatus provided with a fluid dispensing device for dispensing at least a first fluid, such as a gas and/or liquid, under pressure to the exchangeable holder for preparing a beverage suitable for consumption, the exchangeable holder comprises:
at least a first storage space which is filled with a second fluid such as a concentrate,
at least a first mixing chamber,
at least one outflow opening which is in fluid communication with the first mixing chamber for dispensing the beverage from the first mixing chamber,
at least a first fluid communication between the first storage space and the first mixing chamber for dispensing the second fluid to the first mixing chamber,
at least one inlet opening which, in use, is detachably connected to an outlet opening of the fluid dispensing device for supplying the first fluid to the first mixing chamber, while the first storage space forms part, at least partly, of a dosing device designed for supplying the second fluid in a dosed manner from the first storage space to the first mixing chamber, while, in use, the first fluid is also supplied under pressure to the first mixing chamber so that the second fluid and the first fluid mix together for obtaining the beverage which, then, leaves the holder via the outflow opening,
a first wall part and a second wall part which extend at least substantially along the same imaginary plane surface, while the first wall part bounds a first part of the first mixing chamber and the second wall part bounds a first part of the first storage space,
a third wall part bounding a second part of the first mixing chamber,
a fourth wall part bounding a second part of the first storage space, while a height of the first mixing chamber in relation to the first wall part is smaller than a height of the first storage space in relation to the second wall part.

2. A holder according to claim 1, wherein the height of the first mixing chamber is an external height of the first mixing chamber and the height of the first storage space is an external height of the first storage space.

3. A holder according to claim 1, wherein the first wall part is of elongated design while the greatest width of the first wall part, perpendicular to a longitudinal direction of the first wall part, is smaller than a greatest width of the second wall part and/or approximately equal to the distance mentioned in claim 7.

4. A holder according to claim 1, wherein the first wall part is of elongated designed while a greatest length of the first wall part, in a longitudinal direction of the first wall part, is smaller than a greatest width of the second wall part.

5. A holder according to claim 1, wherein the first mixing chamber is of elongated design.

6. A holder according to claim 1, wherein the first wall part is of elongated designed while a line perpendicular to a longitudinal direction of the first wall part, through a center of the length of the first wall part in the longitudinal direction of the first wall part, and located in the plane of the first wall part, crosses the second wall part and/or intersects the fourth wall part.

7. A holder according to claim 1, wherein a longitudinal direction of the first mixing chamber is parallel to the first wall part and is directed virtually parallel to a line situated in the plane of the first wall part, and which is a tangent line on the fourth wall part at a point of the fourth wall part where the distance between the third wall part and the fourth wall part in the plane of the first wall part is minimal.

8. A holder according to claim 1, wherein the holder is further provided with a second storage space which is filled with a fourth fluid such as a concentrate and a second fluid communication between the second storage space and the first mixing chamber for dispensing the fourth fluid to the first mixing chamber, while the second storage space forms part, at least partly, of a dosing device which is designed for dosed supply of the fourth fluid from the second storage space to the first mixing chamber while, in use, the first fluid is also supplied under pressure to the first mixing chamber so that, on the one side, the second fluid and/or the fourth fluid and, on the other side, the first fluid, mix together for obtaining the beverage which then leaves the holder via the outflow opening wherein the holder is provided with a fifth wall part extending at least substantially along the imaginary plane surface, while the fifth wall part bounds a first part of the second storage space, and wherein the holder is further provided with a sixth wall part bounding a second part of the second storage space, a height of the first mixing chamber in relation to the first wall part being smaller than a height of the second storage space in relation to the fifth wall part.

9. A holder according to claim 8, wherein the height of the second storage space is an external height of the second storage space.

10. A holder according to claim 8, wherein the first mixing chamber is located between the first storage space and the second storage space.

11. A holder according to claim 8, wherein the first wall part is of elongated design while a greatest width of the first wall part perpendicular to a longitudinal direction of the first wall part is smaller than a greatest width of the fifth wall part and/or approximately equal to the distance mentioned in claim 14.

12. A holder according to claim 10, wherein the first wall part is of elongated design, while a greatest length of the first wall part in a longitudinal direction of the first wall part is smaller than a greatest width of the fifth wall part.

13. A holder according to claim 8, wherein the first wall part is of elongated design, while a line perpendicular to a longitudinal direction of the first wall part, through a center of the length of the first wall part in the longitudinal direction of the first wall part and located in the plane of the first wall part, crosses the fifth wall part and/or intersects the sixth wall part.

14. A holder according to claim 8, wherein a longitudinal direction of the first mixing chamber is parallel to the first wall part and is directed at least virtually parallel to a line situated in the plane of the first wall part and which is a tangent line on the sixth wall part at a point of the sixth wall part where the distance between the sixth wall part and the third wall part in the plane of the first wall part is minimal.

15. A holder according to claim 1, wherein the first wall part and the second wall part are manufactured in one piece.

16. A holder according to claim 1, wherein the third wall part and the fourth wall part are manufactured in one piece.

17. A holder according to claim 1, wherein, combined, the first wall part and the third wall part form the first mixing chamber.

18. A holder according to claim 1, wherein, combined, the second wall part and the fourth wall part form the first storage space.

19. A holder according to claim 8, wherein the first wall part, the second wall part and the fifth wall part are manufactured in one piece.

20. A holder according to claim 8, wherein the third wall part, the fourth wall part and the sixth wall part are manufactured in one piece.

21. A holder according to claim 8, wherein, combined, the fifth wall part and the sixth wall part form the second storage space.

22. A holder according to claim 1, wherein the first wall part, the second wall part, the third wall part and the fourth wall part each form part of an outside wall of the holder.

23. A holder according to claim 8, wherein the first wall part, the second wall part, the third wall part and the fourth wall part, the fifth wall part and the sixth wall part each form part of an outside wall of the holder.

24. A holder according to claim 1, wherein the first wall part and the second wall part are manufactured from a foil, and the third wall part and the fourth wall part are manufactured from a material that is more rigid than the foil.

25. A holder according to claim 24, wherein the holder is designed as a blister pack.

26. A holder according to claim 8, wherein the first wall part, the second wall part and the fifth wall part are manufactured from a foil and the third wall part, the fourth wall part and the sixth wall part are manufactured from a material that is more rigid than the foil.

27. A holder according to claim 26, wherein the holder is designed as a blister pack.

28. A holder according to claim 1, wherein the holder is designed in a manner such that, in use, a third fluid can be supplied in a controllable manner, under pressure, by the apparatus, to the second fluid in the first storage space for dispensing the second fluid in a dosed manner from the first storage space to the first mixing chamber.

29. A holder according to claim 28, wherein the holder is designed in a manner such that, in use, the second fluid can be supplied in a dosed manner from the first storage space to the first mixing chamber by means of pressurizing the second fluid with the pressure of the third fluid.

30. A holder according to claim 1, wherein the fourth wall part is manufactured from a flexible or deformable material so that the storage space can be squeezed together for said dosed supply of the second fluid from the first storage space to the first mixing chamber.

31. A holder according to claim 8, wherein the holder is designed in a manner such that, in use, a fifth fluid can be supplied, in a controlled manner, under pressure, by the apparatus, to the fourth fluid in the second storage space for dispensing the fourth fluid in a dosed manner from the second storage space to the first mixing chamber.

32. A holder according to claim 31, wherein the holder is designed in a manner such that, in use, the fourth fluid can be supplied in a dosed manner from the second storage space to the first mixing chamber by means of pressurizing the fourth fluid with the pressure of the fifth fluid.

33. A holder according to claim 8, wherein the sixth wall part is manufactured from a flexible or deformable material so that the second storage space can be squeezed together for said dosed supply of the fourth fluid from the second storage space to the first mixing chamber.

34. A system for preparing a predetermined amount of a beverage suitable for consumption, the system comprising:
an exchangeable holder and an apparatus provided with a fluid dispensing device which is detachably connected to the holder for dispensing at least an amount of at least the first fluid such as liquid and/or a gas, in particular such as water and/or steam, under pressure to the exchangeable holder, wherein the at least one inlet opening is detachably connected to an outlet opening of the fluid dispensing device for supplying the first fluid to the first mixing chamber, the holder including:
at least a first storage space which is filled with a second fluid such as a concentrate,
at least a first mixing chamber,
at least one outflow opening which is in fluid communication with the first mixing chamber for dispensing the beverage from the first mixing chamber,
at least a first fluid communication between the first storage space and the first mixing chamber for dispensing the second fluid to the first mixing chamber,
at least one inlet opening which, in use, is detachably connected to an outlet opening of the fluid dispensing device for supplying the first fluid to the first mixing chamber,
a dosing device which is designed for supplying the second fluid in a dosed manner from the first storage space to the first mixing chamber, the fluid dispensing device being designed for supplying the first fluid under pressure to the first mixing chamber so that in the first mixing chamber, the first fluid and the second fluid mix together for obtaining the beverage which then leaves the exchangeable holder via the outflow opening.

35. A system according to claim 34, wherein the dosing device is designed for supplying the second fluid in a dosed manner from the first storage space to the first mixing chamber by means of supplying the third fluid, such as a gas or a liquid, in a controllable manner, under pressure, to the second fluid in the first storage space.

36. A system according to claim 35, wherein the dosing device is designed for supplying the second fluid in a dosed manner from the first storage space to the first mixing chamber by means of pressurizing the second fluid with the pressure of the third fluid.

37. A system according to claim 34, wherein the dosing device for said dosed supply of the second fluid from the first storage space to the first mixing chamber is provided with a compressing unit for compressing the first storage space.

38. A system according to claim 34, further comprising a holder receiving portion which is designed for detachably receiving the holder for preparing a beverage suitable for consumption, which holder receiving portion is provided with recesses for receiving at least the first storage space, the first mixing chamber and the first fluid communication, which recesses, viewed in cross-sections through a plane parallel to the first wall part of the holder received in the holder receiving portion, have contours which correspond at least partly to contours of said first mixing chamber, the first storage space and the first fluid communication.

39. A system according to claim 38, wherein the contours of the holder receiving portion correspond to the contours of the first mixing chamber, the first storage space and the first fluid communication.

40. A system according to claim 34, wherein the dosing device which is designed for dosed supply of the fourth fluid from the second storage space to the first mixing chamber, the fluid dispensing device being designed for supplying the first fluid under pressure to the first mixing chamber so that in the first mixing chamber, on the one side, the first fluid and, on the other side, the second fluid and/or the fourth fluid, mix together for obtaining the beverage which then leaves the exchangeable holder via the outflow opening.

41. A system according to claim 40, wherein the dosing device is designed for said dosed supply of the fourth fluid from the second storage space to the first mixing chamber by means of supplying a fifth fluid, such as gas or a liquid, in a controllable manner, under pressure, to the fourth fluid in the second storage space.

42. A system according to claim 41, wherein the dosing device is designed for dosed supply of the fourth fluid from the second storage space to the first mixing chamber by means of pressurizing the fourth fluid with the pressure of the fifth fluid.

43. A system according to claim 40, wherein the dosing device for said dosed supply of the fourth fluid from the second storage space to the first mixing chamber is provided with a compressing unit for compressing the second storage space.

44. A system according to claim 40, further comprising a holder receiving portion which is designed for detachably receiving the holder for preparing a beverage suitable for consumption, which holder receiving portion is provided with recesses for receiving at least the first storage space, the second storage space, the first mixing chamber and the first fluid communication, which recesses, viewed in cross-sections through a plane parallel to the first wall part of the holder received in the holder receiving portion, have contours which correspond at least partly to contours of said first mixing chamber, the first storage space, the second storage space and the first fluid communication.

45. A system according to claim 44, wherein the contours of the holder receiving portion correspond to the contours of the first mixing chamber, the first storage space and the first fluid communication.

46. An apparatus provided with a fluid dispensing device for dispensing at least a first fluid, such as a gas and/or liquid, under pressure to an exchangeable holder having at least a first storage space which is filled with a second fluid, at least a first mixing chamber, at least a first fluid communication between the first storage space and the first mixing chamber for dispensing the second fluid to the first mixing chamber, the apparatus comprises:
a holder receiving portion which is designed for detachably receiving the holder for preparing a beverage suitable for consumption, which holder receiving portion is provided with recesses for receiving at least the first storage space, the first mixing chamber and the first fluid communication, which recesses, viewed in cross-sections through a plane parallel to the first wall part of the holder received in the holder receiving portion, have contours which correspond at least partly to contours of said first mixing chamber, the first storage space and the first fluid communication.

47. An apparatus according to claim 46, wherein the apparatus is further provided with dosing means for supplying a third fluid, such as a gas or a liquid, in a controllable manner, under pressure, to the second fluid in the first storage space for dosed supply of the second fluid from the first storage space to the first mixing chamber.

48. An apparatus according to claim 47, wherein the dosing means are designed for pressurizing the second fluid with the pressure of the third fluid.

49. An apparatus provided with a fluid dispensing device for dispensing at least a first fluid, such as a gas and/or liquid, under pressure to the exchangeable holder having at least a first storage space which is filled with a second fluid, at least a first mixing chamber, at least a first fluid communication between the first storage space and the first mixing chamber for dispensing the second fluid to the first mixing chamber, a second storage space which is filled with a fourth fluid such as a concentrate, and a second fluid communication between the second storage space and the first mixing chamber for dispensing the fourth fluid to the first mixing chamber, the apparatus comprising:
a holder receiving portion which is designed for detachably receiving the holder for preparing a beverage suitable for consumption, which holder receiving portion is provided with recesses for receiving at least the first storage space, the second storage space, the first mixing chamber, the first fluid communication and the second fluid communication, which recesses, viewed in cross-sections through a plane parallel to the first wall part of the holder received in the holder receiving portion, have contours which correspond, at least partly to contours of said first mixing chamber, the first storage space, the second storage space, the first fluid communication and the second fluid communication.

50. An apparatus according to claim 49, wherein the contours of the holder receiving portion correspond substantially completely to the contours of the first mixing chamber, the first storage space and the first fluid communication.

51. An apparatus according to claim 49, wherein the apparatus is further provided with dosing means for supplying the third fluid, such as a gas or a liquid, in a controllable manner, under pressure, to the second fluid in the first storage space for dosed supply of the second fluid from the first storage space to the first mixing chamber and for supplying the fifth fluid, such as a gas or a liquid, in a controllable manner, under pressure, to the fourth fluid in the second storage space for dosed supply of the fourth fluid from the second storage space to the first mixing chamber.

52. An apparatus according to claim 51, wherein the dosing means are designed for pressurizing the second fluid with pressure of the third fluid and for pressurizing the fourth fluid with the pressure of the fifth fluid.

53. A method for preparing a predetermined amount of beverage suitable for consumption having an exchangeable holder with at least a first storage space which is filled with a second fluid, at least a first mixing chamber, at least a first fluid communication between the first storage space and the first mixing chamber for dispensing the second fluid to the first mixing chamber, the method comprising:
supplying at least an amount of at least the first fluid, such as a liquid and/or a gas, in particular such as water and/or steam, under pressure to the first mixing chamber of the exchangeable holder,
supplying the second fluid in a dosed manner from the first storage space to the first mixing chamber, so that in the first mixing chamber, the first fluid and the second fluid mix together for obtaining the beverage which then leaves the exchangeable holder via the outflow opening.

54. A method according to claim 53, comprising
detachably connecting the holder with an apparatus, the apparatus being provided with a fluid dispensing device with an outlet opening which is detachably connected to the at least one inlet opening of the holder for dispensing the first fluid under pressure to the first mixing chamber.

55. A method according to claim 54, wherein the apparatus also comprises dosing means which are designed for supplying a third fluid, such as a gas or a liquid, in a controllable manner, under pressure, to the second fluid in the first storage space for dosed supply of the second fluid from the first storage space to the first mixing chamber.

56. A method according to claim 55, comprising pressurizing the second fluid with the pressure of the third fluid for dosed supply of the second fluid from the first storage space to the first mixing chamber.

57. A method according to claim 54, wherein the apparatus also comprises dosing means which are provided with a compressing unit for compressing the first storage space for said dosed supply of the second fluid from the first storage space to the first mixing chamber.

58. A method according to claim 53, further comprising
providing the holder with a second storage space which is filled with a fourth fluid such as a concentrate, and a second fluid communication between the second storage space and the first mixing chamber for dispensing the fourth fluid to the first mixing chamber,
supplying the fourth fluid in a dosed manner from the second storage space to the first mixing chamber, so that in the first mixing chamber, on the one side the first fluid, and, on the other side, the second fluid and/or the fourth fluid, mix together for obtaining the beverage which then leaves the exchangeable holder via the outflow opening.

59. A method according to claim 58, wherein the dosing means are also designed for supplying a fifth fluid, such as a gas or a liquid, in a controllable manner, under pressure, to the fourth fluid in the second storage space for dosed supply of the fourth fluid from the second storage space to the first mixing chamber.

60. A method according to claim 59, comprising pressurizing the fourth fluid with the pressure of the fifth fluid for dosed supply of the fourth fluid from the second storage space to the first mixing chamber.

61. A method according to claim 58, wherein the dosing means are further provided with a compressing unit for compressing the second storage space for said dosed supply of the fourth fluid from the second storage space to the first mixing chamber.

62. A method according to claim 53, comprising
placing the holder in a holder receiving portion which is designed for detachably receiving the holder for preparing a beverage suitable for consumption, which holder receiving portion is provided with recesses for receiving at least the first storage space, the first mixing chamber and the first fluid communication, which recesses, viewed in cross-sections through a plane parallel to the first wall part of the holder received in the holder receiving portion, have contours which correspond at least partly to contours of said first mixing chamber, the first storage space and the first fluid communication.

63. A method according to claim 62, wherein the contours of the holder receiving portion correspond substantially completely to the contours of the first mixing chamber, the first storage space and the first fluid communication.
